(19) United States
(12) Patent Application Publication
(10) Pub. No.: US 2012/0224854 A1
(43) Pub. Date: Sep. 6, 2012

(54) USE OF THE SAME SET OF WAVELENGTHS FOR UPLINK AND DOWNLINK SIGNAL TRANSMISSION

(75) Inventors: Jianming Tang, Harlow Essex (GB); Jinlong Wei, Cambridge (GB)

(73) Assignee: Bangor University, Bangor Gwynedd (GB)

(21) Appl. No.: 13/504,707

(22) PCT Filed: Oct. 29, 2010
(86) PCT No.: PCT/EP10/66475

§ 371 Date: May 25, 2012

(30) Foreign Application Priority Data
Oct. 30, 2009 (GB) 0919029.9

(51) Int. Cl. H04J 14/00

(52) U.S. Cl. 398/66

(57) ABSTRACT

The present invention relates to the field of signal transmission using orthogonal optical frequency division multiplexing transceivers and to the use of the same set of wavelengths for the downlink and uplink signal transmission.

### FIELD OF THE INVENTION

The present invention relates to the field of signal transmission using optical orthogonal frequency division multiplexing (OOFDM) transceivers and the use of the same set of wavelengths for uplink and downlink signal transmission in wavelength multiplexed-passive optical networks (WDM-PONS).

### DESCRIPTION OF THE RELATED ART

WDM-PONS have been considered as a promising solution for providing broadband services to end-customers, as they offer several excellent features such as, for example, high quality data service with guaranteed wide bandwidth, large split ratio, extended transmission reach, aggregated traffic backhauling, simplified network architecture and enhanced end user privacy as described for example in Grobe and Elbers (K. Grobe and J.-P. Elbers, in IEEE Commun. Mag. vol. 46, no. 1, pp. 26-34, 2008) or in Shumate (P. W. Shumate in J. Lightwave Technol., vol 26, no. 9, pp. 1093-1103, 2008).

It is well known that the use of the optical orthogonal frequency division multiplexing (OOFDM) technique can mitigate the optical modal dispersion effect in multimode fibre (MMF) transmission links, as disclosed for example in Jolley et al. (N. E. Jolley, H. Kee, R. Richard, J. Tang, K. Cordina, presented at the National Fibre Optical Fibre Engineers Conf., Anaheim, Calif., Mar. 11, 2005, Paper OFP3). It can also be used advantageously for chromatic dispersion compensation in single mode fibre (SMF)-based long distance transmission systems such as described for example by Lowery et al. (A. J. Lowery, L. Du, J. Armstrong, presented at the National Fibre Optical Fibre Engineers Conf., Anaheim, Calif., Mar. 5, 2006, paper PDP39) or by Djordjevic and Vasic (I. B. Djordjevic and B. Vasic, in Opt. express, 14, no 9, 37673775, 2006).

Apart from that, it also offers the advantages including, for example, efficient use of channel spectral characteristics, cost-effectiveness due to full use of mature digital signal processing (DSP), dynamic provision of hybrid bandwidth allocation in both the frequency and time domains, and significant reduction in optical network complexity.

The transmission performance of OOFDM has been studied and reported for all the optical network scenarios including long-haul systems such as described for example in Masuda et al. (H. Masuda, E. Yamazaki, A. Sano, T. Yoshimatsu, T. Kobayashi, E. Yoshida, Y. Miyamoto, S. Matsuoka, Y. Takatori, M. Mizoguchi, K. Okada, K. Hagimoto, T. Yamada, and S. Kamei, “13.5-Tb/s (135×111-Gb/s/ch) no-guard-interval coherent OFDM transmission over 6248 km using SNR maximized second-order DRA in the extended L-band,” Optical Fibre Communication/National Fibre Optic Engineers Conference (OFC/NFOEC), (OSA, 2009), Paper PDPB5) or in Schmidt et al. (B. J. C. Schmidt, Z. Zan, L. B. Du, and A. J. Lowery, “100 Gbit/s transmission using single-band direct-detection optical OFDM,” Optical Fibre Communication/National Fibre Optic Engineers Conference (OFC/NFOEC), (OSA, 2009), Paper PDPC3) or metropolitan area networks such as described for example in Duong et al. (T. Duong, N. Genay, P. Chanclou, B. Charbonnier, A. Pizzinat, and R. Brenot, “Experimental demonstration of 10 Gbit/s for upstream transmission by remote modulation of 1 GHz RSOA using Adaptively Modulated Optical OFDM for WDM-PON single fiber architecture,” European Conference on Optical Communication (ECOC), (Brussels, Belgium, 2008), PD paper Th.3.F.1) or in Chow et al. (C.-W. Chow, C.-H. Yeh, C.-H. Wang, F.-Y. Shih, C.-L. Pan and S. Chi, “WDM extended reach passive optical networks using OFDM-QAM,” Optics Express, 16, 12096-12101, July 2008), or local area networks such as described for example in Qian et al. (D. Qian, N. Cvijetic, J. Hu, and T. Wang, “108 Gb/s OFDMA-PON with polarization multiplexing and direct-detection,” Optical Fibre Communication/National Fibre Optic Engineers Conference (OFC/NFOEC), (OSA, 2009), Paper PDPD5) or in Yang et al. (H. Yang, S. C. J. Lee, E. Tangdiongga, F. Breyer, S. Randel, and A. M. J. Koonen, “40-Gb/s transmission over 100 m graded-index plastic optical fibre based on discrete multi-tone modulation,” Optical Fibre Communication/National Fibre Optic Engineers Conference (OFC/NFOEC), (OSA, 2009), Paper PDPD8).

All prior art existing systems were based on transmission of OOFDM signals originating from arbitrary waveform generators (AWG) using off-line signal processing-generated waveforms. At the receiver, the transmitted OOFDM signals were captured by digital storage oscilloscopes (DSO) and the captured OOFDM symbols were processed off-line to recover the received data. Such off-line signal processing approaches did not consider the limitations imposed by the precision and speed of practical DSP hardware required for insuring real-time transmission.

It has been improved by introducing signal modulation technique known as adaptively modulated optical OFDM (AMOOFDM), offering advantages such as:
Improved system flexibility, performance robustness, transmission performance and system compatibility;
efficient use of spectral characteristics of transmission links and adaptively of imperfect system and network components; individual subcarrier power and bits within an OFDM symbol can be modified according to needs in the frequency domain;
use of existing network infrastructure;
low installation and maintenance cost.

These have been described and discussed for example in Tang et al. (J. Tang, P. M. Lane and K. A. Shore in IEEE Photon. Technol. Lett, 18, no 1, 205-207, 2006 and in J. Lightw. Technol., 24, no 1, 429-441, 2006) or in Tang and Shore (J. Tang and K. A. Shore, in J. Lightw. Technol., 24, no 6, 2318-2327, 2006). Additional aspects such as
impact of signal quantisation and clipping effect related to analogue to digital conversion (ADC) and determination of optimal ADC parameters;
maximisation of the transmission performance;

have also been described in Tang and Shore (J. Tang and K. A. Shore, in J. Lightw. Technol., 25, no 3, 787-798, 2007).

Some documents have also disclosed systems wherein the same wavelength can be used for downlink and uplink transmission. For example US-A-2006/0093360 discloses a system wherein two separate fibres are used for downlink and uplink transmission, but it is not related to OFDM signal transmission. Other publications such as Huang et al. (Yin-Hsun Huang; Gong-Cheng Lin; Hai-Lin Wang; Yi-Hung Lin; Sun-Chien Ko; Jy-Wang Liaw; Gong-Ru Lin; “Weak-resonant-cavity FPLD based down-stream amplitude squeezer for injection-locking RSOA transmitter in DWDM-PON,” Lasers and Electro-Optics, 2009 and 2009 Conference on Quantum electronics and Laser Science Conference. CLEO/QELS 2009. Conference on, vol., no., pp. 1-2, 2-4 June 2009) disclose the use of a reflective semiconductor optical amplifier (RSOA) having a special design to reduce cross-talk between downlink and uplink signals. It is however only valid for relatively low signal bit rates. Takesue et al. (Takesue, H.; Sugie, T.; “Wavelength channel data rewrite using saturated SOA modulator for WDM networks with centralized light sources,” Lightwave Technology, Journal of, vol. 21, no. 11, pp. 2546-2556, November 2003) discloses the use of a SOA to clean the downlink signal and modulate the uplink signal but it is not designed for OFDM signal transmission. Huang et al. (Ming-Fang Huang; Jianjun Yu; Hung-Chang Chien; Chowdhury, A.; Chen, J.; Sien Chi; Gee-Kung Chang; “A Simple WDM-PON Architecture to Simultaneously Provide Triple-play Services by Using One Single Modulator,” Optical Fiber communication/National Fiber Optic Engineers Conference, 2008. OFC/NFOEC 2008. Conference on, vol., no., pp. 1-3, 24-28 February 2008) discloses a system wherein two separate fibres are used for downlink and uplink transmission and addresses transmission of low signal speed. Cho et al. (Cho, Seung-Hyun; Lee, Wooram; Park, Mahn Yong; Lee, Jiehyun; Kim, Chulyoung; Jeong, Geon; Kim, Byoungwhi; “Demonstration of Burst Amplified Uplink for RSOA-based WDM/TDM Hybrid PON Systems Using SOA as a Multi-Channel Preamplifier,” Optical Communications, 2006. ECOC 2006. European Conference on, vol., no., pp. 1-2, 24-28 September 2006) discloses a system for uplink transmission only. Also it is used in a WDM/TDM PON architecture. Bock et al. (Bock, C.; Prat, J.; Walker, S. D.; “Hybrid WDM/TDM PON using the AWG FSR and featuring centralized light generation and dynamic bandwidth allocation,” Lightwave Technology, Journal of, vol. 23, no. 12, pp. 3981-3988, December 2005) disclose a single direction transmission and does not use RSOA but arrayed waveguide grating (AWG).

None of these documents address the two important problems of cross-talk between downlink and uplink signals and the back Raleigh scattering effect. These two factors determine the maximum achievable signal transmission performance. For example, without compensating these two effects, the achieved maximum uplink signal bit rates is of less than 7 Gb/s over 25 km.

Significantly advanced technologies are still required to further improve the system performance using the same sets of wavelengths and/or fibres for downlink and uplink signal transmission.

### SUMMARY OF THE INVENTION

It is an objective of the present invention to ensure improved input/output reconfigurability and dynamic bandwidth allocation without modifying the optical network architecture.

It is also an objective of the present invention to use the same set of wavelengths for downlink and uplink signal transmission in WDM-PONS.

It is a further objective of the present invention to use the same fibres for downlink and uplink signal transmission in WDM-PONS.

It is another objective of the present invention to provide colourless optical transceivers within a broad wavelength window, at least in the C-band.

It is yet another objective of the present invention to provide pre-compensation of transmission link spectral distortion without additional hardware.

It is also an objective of the present invention to reduce cross-talk between downlink and uplink transmission.

It is a further objective of the present invention to reduce the back Raleigh scattering effect.

It is yet a further objective of the present invention to simplify the architecture of the transceiver in optical network units by optimising the operating conditions of the reflective semiconductor amplifiers (RSOA).

It is also an objective of the present invention to optimise the design of the RSOA.

In accordance with the present invention, the foregoing objectives are realised as defined in the independent claims. Preferred embodiments are defined in the dependent claims.

### BRIEF DESCRIPTION OF THE DRAWINGS

FIG. 1 represents a diagram of the passive optical network of the present invention.

FIG. 2 is a schematic diagram of a reflective semiconductor optical amplifier (RSOA).

FIG. 3 represents the signal line rate expressed in Gb/s as a function of transmission distance expressed in km for semiconductor optical amplifier (SOA) and for reflective semiconductor optical amplifier (RSOA) having rear-facet reflectivities of 0.3 and 0.9 when used respectively with fibre dispersion and without fibre dispersion.

FIG. 4 represents the optical gain expressed in dB as a function of optical input power expressed in dBm for SOA and RSOAs having respectively rear facet reflectivities of 0.3, 0.6 and 0.9, for a bias current of 100 mA.

FIG. 5 represents the optical gain expressed in dB as a function of bias current expressed in mA for SOA and RSOAs having respectively rear facet reflectivities of 0.3, 0.6 and 0.9, for an injected optical power of −10 dBm.

FIG. 6 represents the optical gain expressed in dB as a function of bias current expressed in mA for SOA and RSOAs having respectively rear facet reflectivities of 0.3, 0.6 and 0.9, for an injected optical power of +10 dBm.

FIG. 7 represents the experimental system setup for colourless real-time optical orthogonal frequency division multiplexing (OOFDM) transmission using RSOA as intensity modulator.

FIG. 8a represents the normalised power expressed in dB as a function of frequency expressed in MHz for 5 different scenarios: 1) RSOA alone; 2) electrical analogue back-to-back configuration, in which only DAC frequency response is present; 3) combined contributions from RSOA and DAC; 4) optical back-to-back configuration from the inverse fast Fourier transform (IFFT) in the transmitter to the fast Fourier transform (FFT) in the receiver; and 5) entire 25 km transmission system.

FIG. 8b represents the normalised transmitted and received subcarrier power expressed in dB as a function of frequency expressed in MHz at a wavelength of 1550 nm, for optical back-to-back and for 25 km SSMF configurations. It also represents the error distribution expressed in % as a function of frequency.

FIG. 9 represents the bit error rate (BER) performance for optical back-to-back configuration and for transmission over a 25 km SSMF for wavelengths of 1535, 1540, 1550 and 1560 nm.

### DESCRIPTION OF THE PREFERRED EMBODIMENTS

The present invention discloses an OFDM-based Passive Optical Network (PON) architecture that uses the same set of wavelengths for downlink and uplink signal transmission and that comprises:

a) a power splitter;

b) an optical coupler per end user;

c) a photodetector linked to the user-fraction of the signal exiting the optical coupler of step b)

d) an optical circulator having 3 ports, port 1 for incoming signal, port 2 for transmitting the signal towards a RSOA device and for receiving the end user uplink signal and port 3 for transmitting the uplink signal;

e) a signal cleaning and signal receiving device consisting either of two serially connected SOAs or a SOA serially connected to a RSOA or one reflective semiconductor optical amplifier (RSOA);

g) a transmission line connecting either the second of the two SOA system or the RSOA to port 3 of the optical circulator.

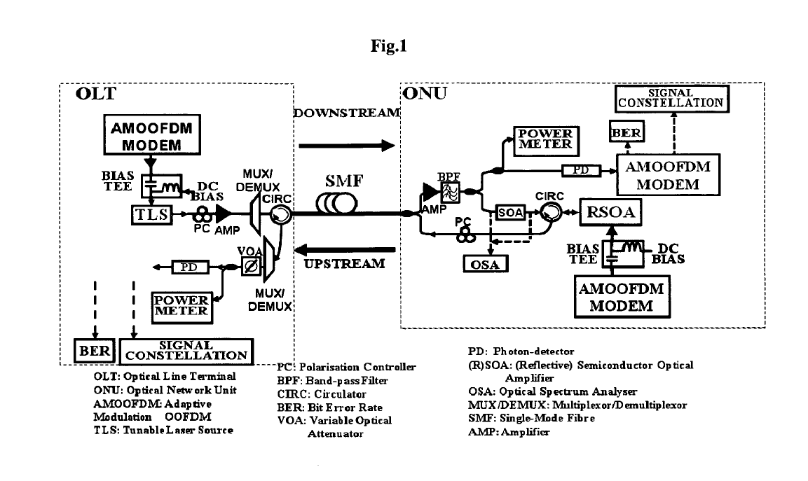

A diagram of the PON architecture of the present invention is displayed in FIG. 1.

The power splitter splits the received downlink optical signal between N end-users, wherein N is 2^{p} with p ranging between 5 and 10. Typically and preferably p is 6.

The optical coupler separates the split optical signal into a fraction sent to the end-user and a fraction used for uplink transmission. The fraction sent to the end user comprises from 30 to 50% of the optical signal, preferably about 40%. The remaining fraction of the signal, from 50 to 70%, preferably about 60% is sent to the signal cleaning device.

The fraction of the downlink signal sent to the optical circulator can optionally be cleaned by a SOA device placed in front of said circulator.

The RSOA device is used to clean the downlink signal and also to transmit the signal originating from the end user. The optical couplers are commercially available with a variety of possible split ratios.

The photodetector is linked to the end-user fraction of the signal exiting optical coupler b) and transmits the signal to the end-user.

The optical circulator has 3 ports: port 1 is used for receiving the incoming, optionally pre-cleaned signal, port 2 is used for transmitting the signal towards the RSOA device and for receiving signal from end-user and port 3 for transmitting the uplink signal.

The downlink electrical signal entering the RSOA device is preferably inverted prior to entering the device in order to reduce the cross talk between downlink and uplink signals

In a first embodiment according to the present invention, the signal cleaning and end-user signal transmitting device consists of two serially connected SOAs.

An optical amplifier is a device that amplifies an optical signal without converting it first to an electrical signal. Incoming light is amplified by stimulated emission in the amplifier's gain medium. In reflective semiconductor optical amplifiers (RSOA), the gain medium is provided by a semiconductor. They have a structure similar to that of Fabry-Perot laser diodes but they additionally include anti-reflection design elements at the endfaces. Endface reflection can be reduced to less than 0.001% by including anti-reflective coatings and/or tilted waveguide and/or window regions. In such structure, the loss of power from the cavity is greater than the gain, thereby preventing the amplifier from acting as a laser. They are typically prepared from compounds including metals Group 13 to 15 of the periodic Table such as for example GaAs/AlGaAs, InP/InGaAs, InP/InGaAsP and InP/InAlGaAs. They typically operate at signal wavelengths between 0.85 μm and 1.6 μm and generate gains of up to 30 dB.

The operating conditions of the SOA need to be optimised in order to reduce the wavelength dependence of OOFDM transmission performance. Optimisation of SOA operating conditions enables the production of OOFDM transmitters that no longer depend upon wavelength and are thus “colourless”. This is carried out by adjusting the bias current, the driving current and the injected optical power.

The optimum SOA operating conditions are wavelength dependent. When CW wavelength increases, the optimum SOA bias current decreases and the optimum optical input power and peak-to-peak power of the driving current remain almost unchanged. The optimum optical input power is required to be wavelength independent. The optimum bias current necessary to achieve this result increases with decreasing wavelength.

At the output of the SOA intensity modulator, the power and phase of the modulated optical signal at time t can be written as

Pₒᵤₜ(t)=Pᵢₙ(t)exp[h(t)]

φₒᵤₜ(t)=φᵢₙ(t)−1/2αh(t)

wherein Pₒᵤₜ and φₒᵤₜ are respectively the power and the phase of the optical output optical signal, whereas Pᵢₙ and φᵢₙ are the power and phase of the optical input signal. h is the integrated SOA optical gain and α is the linewidth enhancement factor. The linear relationship between the input and output optical signals indicates that an extra broadcasting signal and/or a signal undertaking pre-compensation of link spectral distortions can be modulated onto the input optical signal without affecting the transmission performance of the SOA intensity modulators.

The first SOA is used to clean the signal by working in the nonlinear portion of the gain versus input power curve. The large amplitude peaks in the signal are cut off and the small peaks are amplified thereby producing a substantially flat response curve. The signal exiting the first SOA is transmitted to the second SOA that also receives the signal emitted by the end-user for uplink transmission, said end-user signal being superposed to the fairly flat response curve produced by the first SOA.

In a second and preferred embodiment according to the present invention, the two serially connected SOAs are replaced by a RSOA.

Reflective semiconductor optical amplifiers (RSOA) are very desirable for customer optical network units (ONUs) because of their low cost, compactness, low power dissipation, full coverage of the entire fibre transmission window and large-scale monolithic integration capability. They have been used to achieve several key WDM-PON functionalities, such as for example,
signal modulation as described by Cho et al. (K. Y. Cho, Y. Takushima, and Y. C. Chung, in IEEE Photon. Technol. Lett. vol. 20, no. 18, pp. 1533-1535, 2008) or in Omella et al. (M. Omella, V. Polo, J. Lazaro, B. Schrenk and J. Prat, presented at the European Conference on Optical Communication (ECOC), Brussels, Belgium, 2008, PD Paper Tu.3.E.4);
colourless network operation as described by Yeh et al. (C. H. Yeh, C. W. Chow, C. H. Wang, F. Y. Shih, H. C. Chien, and S. Chi, in Opt. Express., vol. 16, no. 16, pp. 12296-12301, 2008); or
bidirectional transmission network architectures as described by Lee et al. (W. Lee, M. H. Park, S. H. Chao, J. Lee, C. Kim, G. Jeong, and B. W. Kim, in IEEE Photon. Technol. Lett. vol. 17, no. 11, pp. 2460-2462, 2005) or in Omella et al. (M. Omella, I. Papagiannakis, B. Schrenk, D. Klonidis, J. A. Lazaro, A. N. Birbas, J. Kikidis, J. Prat, and I. Tomkos, in Opt. Express., vol. 17, no. 7, pp. 5008-5013, 2009).

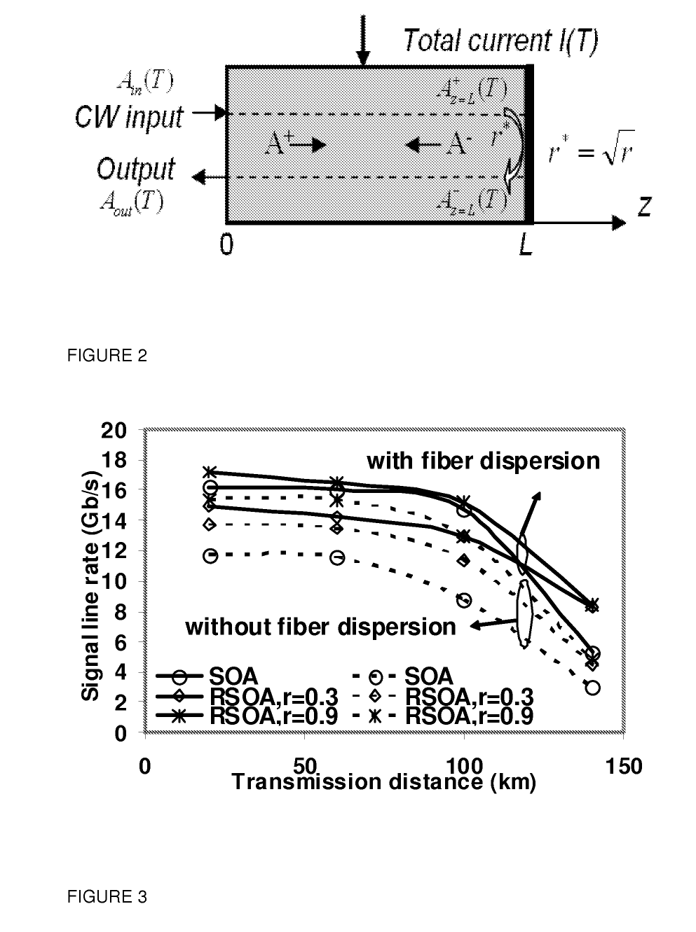

A RSOA is represented in FIG. 2.

Experimental investigations of the transmission performance of RSOA intensity-modulated AMOOFDM signals over intensity modulation and direct detection (IMDD) single mode fibres (SMF) have been reported by Duong et al. (T. Duong, N. Genay, P. Chanclou, B. Charbonnier, A. Pizzinat, and R. Brenot, presented at the European Conference on Optical Communication (ECOC), Brussels, Belgium, 2008, PD Paper Th.3.F.1).

A number of important issues need to be addressed such as the identification of the physical mechanisms affecting RSOA performance in order to optimise RSOA operating conditions and design thereby maximising the transmission performance and the system flexibility and robustness. In addition to the normal bias and driving currents, the RSOA can also be biased by a current which is an inverse of the downlink electrical OFDM signal to reduce the cross-talk effect between the uplink and downlink signals.

It is also advantageous to use the RSOA intensity modulation-induced frequency chirp to compensate for chromatic dispersion of standard single mode fibres (SMFs).

RSOA is a very attractive alternative to SOA because of its low component cost, high optical gain, small noise figure and large optical signal extinction ratio as described for example in Guo et al. (L. Q. Guo, and M. J. Connelly, in Optics Communications. vol. 281, no. 17 pp. 4470-4473, 2008) or in Arellano and Prat (C. Arellano, and J. Prat, presented at the International Conference on Transparent Optical Network (ICTON), 2005. Paper We.A1.4).

SOAs exhibit however better optical linearity because of their higher input saturation powers. SOA intensity modulators can be used in AMOOFDM modems for WDM-PONS as discussed for example in J. L. Wei, A. Hamié, R. P. Giddings, and J. M. Tang, “Semiconductor optical amplifier-enabled intensity modulation of adaptively modulated optical OFDM signals in SMF-based IMDD systems,” J. Lightwave Technol., vol. 27, no. 16, pp. 3679-3689, 2009) or in Wei et al. (J. L. Wei, X. L. Yang, R. P. Giddings and J. M. Tang, in Opt. Express., vol. 17, no. 11, pp. 9012-9027, 2009). These authors have shown that colourless 30 Gb/s SMF transmission of SOA intensity-modulated AMOOFDM signals over a distance of 60 km is feasible over wavelengths ranging from 1510 nm to 1590 nm.

In this second embodiment, the RSOA is linked to port 2 of the optical circulator. The driving current typically ranges between 80 and 120 mA, preferably it is of about 100 mA. If the extinction ratio is too large, signal clipping occurs creating signal distortion.

It must be noted however that a benefit of employing a RSOA operating at a low optical input power is that it can produce a fair amount of controllable negative frequency chirp having a sign opposite to that caused by the dispersion parameter of a standard SMF. Therefore, use can be made of such property to improve either transmission capacity for a fixed link power budget, or link power budget for a fixed transmission capacity. This can be seen for example in FIG. 3 comparing transmission performances for cases with and without chromatic dispersion for SOA and RSOA with various values of the rear facet reflectivity r of the RSOA. It can be seen that the transmission capacity where fibre dispersion is present is enhanced with respect to the case without fibre dispersion over distances of up to 100 km or more. The RSOA negative frequency chirp is function of the operating conditions thereby making the dispersion compensation dynamically controllable. The positive frequency chirp of the SMF is directly proportional to the length. For example, for a typical transmission distance of 80 km, there is a negative power penalty of about 2 dB, meaning that there is an optical power gain of 2 dB. In all cases, optimisation of the RSOA operating conditions and of the RSOA design are very important.

In a third embodiment according to the present invention, the cleaning and user-data receiving system consists of a first SOA serially linked to a RSOA.

The second SOA or the RSOA is also operated to convert the signal generated from the end user to the optical domain for uplink transmission. It is then transmitted to port 2 of the optical circulator via a transmission line.

For uplink transmission, the end-user-generated OOFDM signal is used to drive the SOA/RSOA to modulate the downlink optical signal injected to the SOA/RSOA. The re-modulated optical signal enters at port 2 of the optical circulator and is then coupled into the same fibre link as that used for down transmission. The signal generated by the end user for uplink transmission is a single band signal in order to reduce the back Raleigh scattering effect.

The end-user signal is then transmitted via port 3 of the optical circulator through the same set of wavelengths as the downlink signal.

The present invention also discloses a method for using the same set of wavelengths for both uplink and downlink transmission that comprises the steps of:
a) providing a power splitter for separating the downlink signal between the N users;
b) providing N optical couplers, one for each end user;
c) in each optical coupler, separating the signal into 2 fractions;
d) sending the first fraction of the optical signal to a photodetector in order to obtain an electrical signal and then to the selected end user;
e) inverting the downlink electrical signal;
f) sending the second fraction of the optical signal to port 1 of an optical circulator having at least 3 ports;
g) either sending the signal exiting port 2 of the optical circulator to the first SOA of a system consisting of two serially connected SOAs and then to the second SOA or sending the signal to the SOA of a system consisting of a SOA serially connected to a RSOA then to the RSOA, or sending the signal exiting port 2 of the optical circulator to a RSOA;
h) sending the inverted downlink electrical signal of step e) into the RSOA or second SOA;
i) superposing the single band signal originating from the selected end user onto the clean signal of either the second SOA or the RSOA;
j) sending said selected end user signal to port 2 of the optical circulator via a transmission line;
k) sending the uplink signal entering port 2 of the optical circulator via port 3 of said optical circulator, using the same route as that used for the downlink signal.

The SOA and RSOA are optimised and the operating conditions of the SOA or RSOA are selected to work in the region wherein the gain is constant with respect to the input optical power.

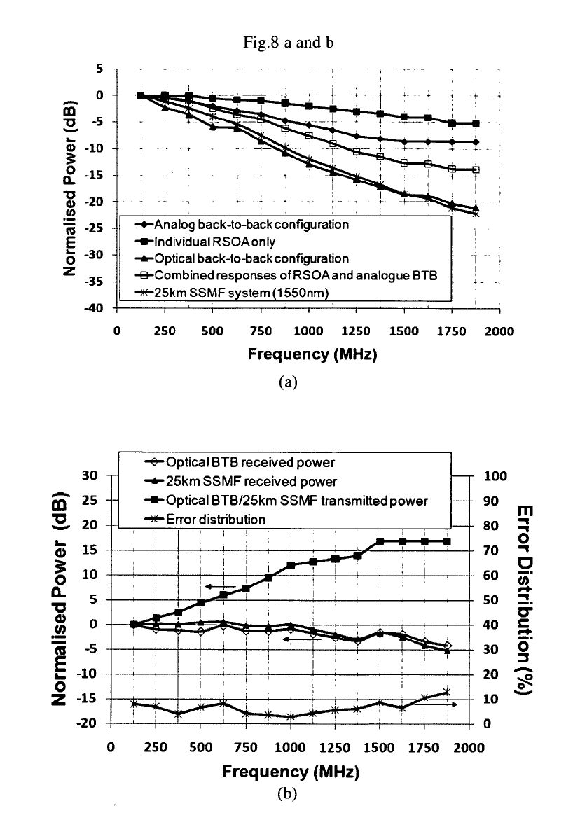

In addition, the power input is modulated in order to obtain optimal amplitude at the receiver end. l is known that the low frequency carrier have a very small loss whereas the high frequency carriers suffer a very large loss. At the receiver end, because of its low amplitude range, the signal is cut off at low frequencies and barely detectable at the high frequency. In order to compensate for that problem, the input power is modulated to provide a low amplitude at low frequencies, said input power increasing progressively toward the high frequencies. This behaviour is displayed in FIG. 8b.

The two main problems of back Raleigh scattering and cross talk between uplink and downlink signals have been substantially reduced respectively by using uplink single band signals and by inverting the electrical downlink signal.

### EXAMPLES

### Example 1

The schematic diagram of the RSOA intensity modulator of a cavity of length L is shown in FIG. 2. A high reflective coating is applied on the rear facet whereas the coating of the front facet is similar to that of a SOA. The reflectivity of the rear facet is denoted by symbol r.

A comparison between the RSOA and SOA performances in terms of optical gain characteristics has been studied, wherein optical gains G_{RSOA} and G_{SOA} at time t are respectively defined by

G_{RSOA}(t)=Pₒᵤₜ(t)/Pᵢₙ( ) and

G_{SOA}(t)=P⁺_{z=L}(t)/Pᵢₙ(t)

wherein Pₒᵤₜ, Pᵢₙ and P⁺ are respectively the powers of the outgoing optical signal, of the incoming optical signal and of the forward propagating optical signal.

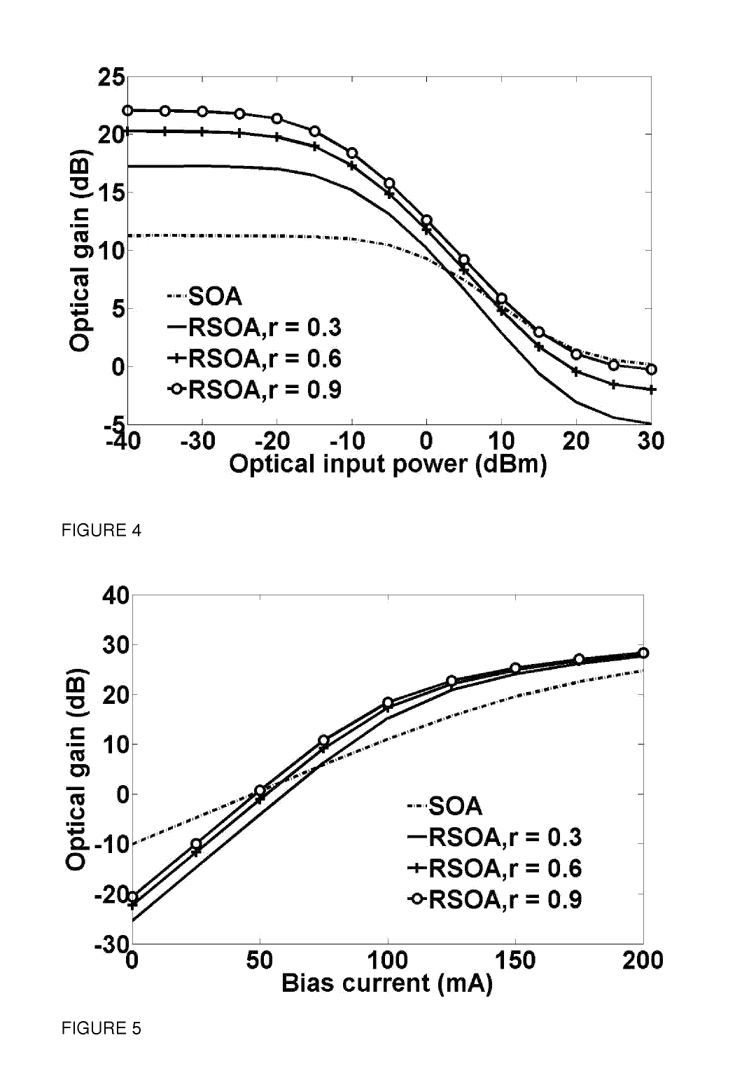

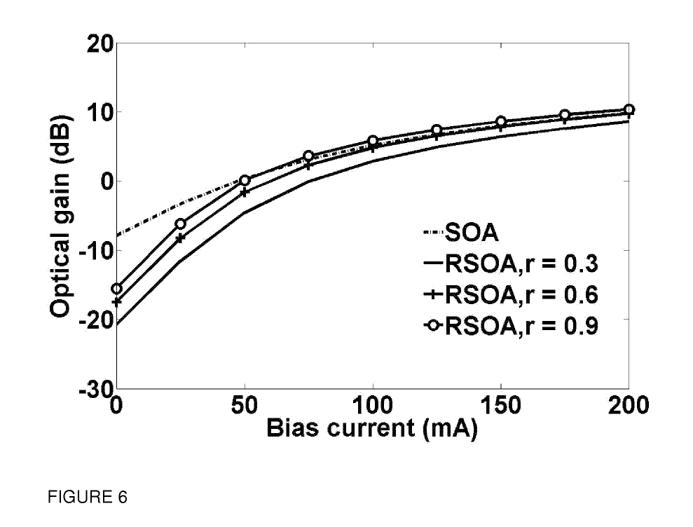

The calculated optical gain as a function of continuous wave (CW) optical input power for SOA and RSOA with various rear facet reflectivity values is represented in FIG. 4. The calculated optical gain as a function of bias current for SOA and RSOA with various rear facet reflectivity values is plotted in FIG. 4 for an injected optical power of −10 dBm and in FIG. 6 for an injected optical power of +10 dBm.

A 10 GHz sinusoidal electrical driving current having a fixed peak-to-peak (PTP) value of 40 mA was applied.

It can be seen from FIGS. 4, 5 and 6 that, the RSOA and the SOA have similar optical gain evolution trends, with however optical gain differences occurring under specific operating conditions. As shown in FIG. 4, for optical input powers of less than −10 dBm, RSOA has a higher optical gain than SOA, said gain increasing with increasing rear facet reflectivity. That behaviour is reversed in the strongly saturated region corresponding to input power of more than 10 dBm.

### Example 2

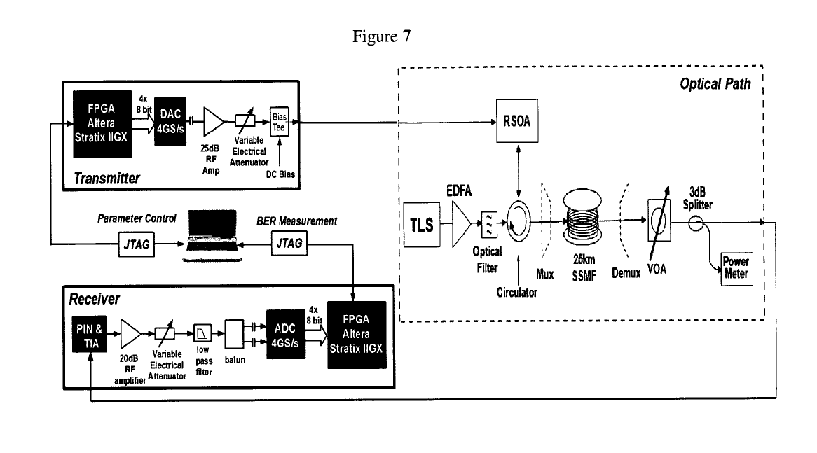

In another example according to the present invention, the performance of a 1 GHz RSOA intensity modulator has been evaluated in the colourless real-time end-to-end optical orthogonal frequency division multiplexing (OFDM) transmission at 7.5 Gb/s over a 25 km standard single mode fibre (SSMF). The experimental setup is displayed in FIG. 7.

An Altera Stratix II GX field programmable gate array (FPGA)-based OOFDM transceiver architecture including real-time digital signal processing (DSP), channel estimation, symbol synchronization, bit error rate (BER) measurement and on-line performance monitoring, were selected as described in Giddings et al. (R. P. Giddings, X. Q. Jin and J. M. Tang in Opt. Express, 17, 2009), except that the intensity modulator was replaced by a RSOA. The digital amplitude on each subcarrier was adjustable on-line. 32 subcarriers were employed with 15 conveying data in the positive frequency bins. An 8-sample cyclic prefix was used, giving 40 samples per OOFDM symbol. The internal system clock was set to 100 MHz and the parallel signal processing approach resulted in a 100 MHz symbol rate. The 8-bit digital to analogue conversion/analogue to digital conversion (DAC/ADC) was operated at 4 GS/s, producing a 2 GHz signal bandwidth. 16-QAM was taken on all the 15 information-bearing subcarriers. The OOFDM transceiver produced a raw signal bit rate of 7.5 Gb/s, of which 6 Gb/s were used to carry user data.

A continuous wave (CW) optical wave was supplied by a tunable laser source, and then passed through an erbium doped fibre amplifier (EDFA) with adjustable optical output power, a multiplexer and an optical circulator having 1.4 dB insertion loss. It was then injected, at an optical power of 5 dBm, into a RSOA having an electrical modulation bandwidth of 1.125 GHz. A 2 GHz 2.1 V peak-to-peak electrical analogue real-time OFDM signal and an 84 mA DC bias current were fed into a 6 GHz bandwidth bias tee to modulate the CW optical wave in the RSOA. The modulated real-time OOFDM signal was then transmitted through a 25 km SSMF with a 5 dB loss.

At the receiver, after passing through a demultiplexer, a variable optical attenuator and a 3 dB coupler, a 12 GHz PIN+TIA photodetector with receiver sensitivity of −17 dBm was employed to convert the transmitted OOFDM signal into the electrical domain for data recovery. The RSOA driving and bias currents as well as the 5 dBm CW optical power were optimum values obtained through parameter optimisation during data transmission. These parameter values remained substantially unchanged for optical wavelengths within the C-band.

The measured frequency responses normalised to the 1^{st} subcarrier are displayed in FIG. 8a for different scenarios:

1) RSOA alone;

2) electrical analogue back-to-back configuration, in which only DAC frequency response is present;

3) combined contributions from both RSOA and DAC;

4) optical back-to-back configuration from the IFFT in the transmitter to the FFT in the receiver;

5) entire 25 km transmission system.

It can be seen from that figure that the 25 km system frequency response decayed by up to 26 dB within the signal spectral region. That rapid roll-off could be attributed mainly to three factors: DAC because of its input filtering; RSOA because of its narrow modulation bandwidth; and signal spectral distortion due to the dynamic RSOA frequency chirp effect, said distortion being very sensitive to operating conditions as discussed by Wei et al. (J. L. Wei, X. Y. Yang, R. P. Giddings and J. M. Tang in Opt. Express, 17, 9012-9027, 2009).

It was observed that at equal power loading, the complex values of the low frequency subcarriers at the output of the FFT overflowed the range of the 8-bit signed value, whilst the constellation points of the high frequency subcarriers started to merge together, resulting in measured total channel BER worse than 1.0×10⁻².

For the optical back-to-back and 25 km SSMF transmission cases, the implementation and effectiveness of the variable power loading technique are displayed in FIG. 8b. The variable power-loaded subcarrier power in the transmitter and the received subcarrier power prior to channel equalisation in the receiver, all normalised to the 1^{st} subcarrier, are displayed as a function of frequency. The error distribution is also displayed on the same graph. The digital subcarrier amplitude on each subcarrier in the transmitter was adjusted in order to ensure a substantially uniform BER distribution of less than 10% over all the subcarriers. In addition, the total channel BER was also minimised.

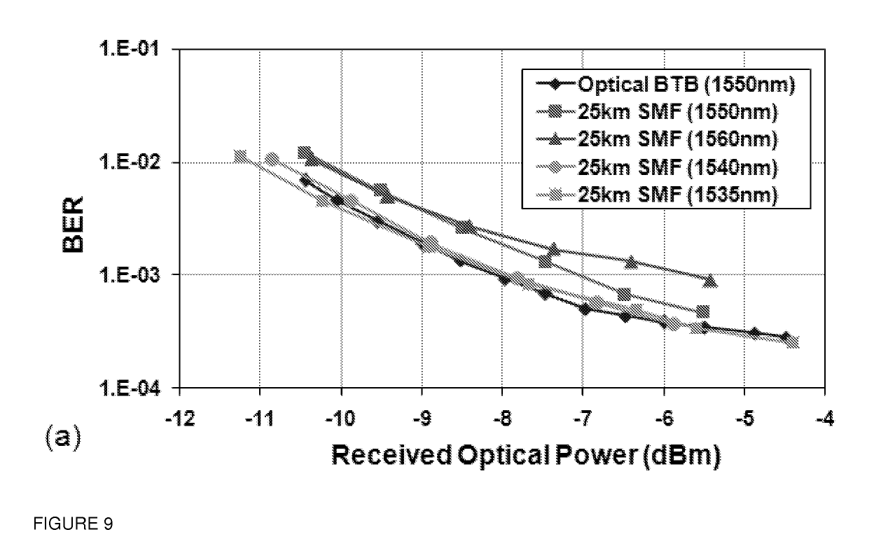

After optimisation of the subcarrier amplitude distribution and the RSOA operating conditions, the BER performance of real-time 7.5 Gb/s over 25 km SSMF end-to-end transmission of OOFDM signals is displayed in FIG. 9 for different wavelengths. It can be seen that, for all the wavelengths across the C-band, the BERs were of less than 1.0×10⁻³ and power penalties of less than 2 dB were achieved, indicating that real-time RSOA-based transceivers were capable of supporting colourless operation. The sharp reduction in power penalty with decreasing optical wavelength, observed in FIG. 9 can be explained by the short wavelength-induced increase in extinction ratio of the RSOA modulated signals.

1. A colourless optical OFDM (OOFDM)-based Passive Optical Network (PON) architecture that uses the same set of wavelengths for downlink and uplink signal transmission, said architecture comprising:
a) a power splitter;
b) an optical coupler per end user;
c) a photodetector linked to the user-fraction of the signal exiting the optical coupler of step b);
d) an optical circulator having 3 ports, port 1 for incoming OOFDM signal, port 2 for transmitting the OOFDM signal towards a RSOA device and for receiving the end user uplink single band signal and port 3 for transmitting the uplink OOFDM signal;
e) a signal cleaning and signal receiving device consisting either of two serially connected SOAs or a SOA serially connected to a RSOA or one reflective semiconductor optical amplifier (RSOA);
f) a transmission line connecting either the second of the two SOA system or the RSOA to port 3 of the optical circulator;
characterized in that colourless operation is achieved by the SOA and/or RSOA intensity modulators.

2. The colourless OOFDM-based PON architecture of claim 1 wherein the signal cleaning and signal receiving devices consist of two serially connected SOA, or a SOA serially connected to a RSOA.

3. The colourless OOFDM-based PON architecture of claim 1 wherein the signal cleaning and signal receiving device consists of one RSOA.

4. A method utilizing the colourless OOFDM-based PON architecture of claim 1 for transmitting the downlink and uplink OOFDM signals through the same set of wavelength and SOA/RSOA intensity modulators that comprises the steps of:
a) providing a power splitter for separating the OOFDM downlink signal between the N users;
b) providing N optical couplers, one for each end user;
c) in each optical coupler, separating the signal into 2 fractions;
d) sending the first fraction of the optical signal to a photodetector in order to produce an electrical signal and then to the selected end user;
e) inverting the downlink electrical signal;
f) sending the second fraction of the optical signal to port 1 of an optical circulator having at least 3 ports;
g) sending the optical signal exiting port 2 of the optical circulator to the RSOA device that also receives a single band signal emitted by the end-user and the inverted downlink signal to a RSOA device;
h) superposing the single band signal originating from the selected end user onto the cleaned signal;
i) sending said selected end-user signal to port 2 of the optical circulator via a transmission line;
j) sending the uplink signal entering port 2 of the optical circulator via port 3 of said optical circulator, using the same route as that used for the downlink signal;
characterized in that the performance of the architecture is wavelength independent.

5. The method of claim 4 wherein the power splitters divides the incoming signal into N users wherein N is 2^{p} with p, ranging between 5 and 10.

6. The method of claim 4 wherein the optical coupler separates the split incoming signal into a 30 to 50% fraction going to the end user and a 50 to 70% fraction sent to the optical circulator.

7. The method of claim 6 wherein the optical coupler separates the split incoming signal into a 40% fraction going to the end user and a 60% fraction sent to the optical circulator.

8. The method of claim 4 wherein the RSOA is replaced by two serially connected SOA or a SOA connected to a RSOA, the first of which being used to clean the downlink signal and the second to receive the signal emitted by the end-user and add it to the cleaned signal transmitted by the first SOA.

9. The method of claim 4 wherein the RSOA has a peak to peak value for the driving current of from 80 to 120 mA, preferably of about 100 mA.

10. The method of claim 1 wherein the input power is modulated to increase amplitude with increasing frequency of the carrier.

11. Use of the PON of claim 1 to utilize the same set of wavelengths for downlink and uplink signal transmission in the same fibre.

12. Use of SOA/RSOA intensity modulators to achieve colourless transmission.

13. Use according to claim 12 wherein the RSOA has a negative frequency chirp in order to compensate for the dispersion parameter of standard SMF.
